(19) United States
(12) Patent Application Publication
(10) Pub. No.: US 2020/0009568 A1
(43) Pub. Date: Jan. 9, 2020

(54) MICROFLUIDIC DEVICE FOR ACCOMMODATING, ISOLATING, TREATING, AND/OR PROCESSING CELLS HAVING AN INLET CHAMBER WITH A CHUTE STRUCTURE

(71) Applicant: KONINKLIJKE PHILIPS N.V., EINDHOVEN (NL)

(72) Inventors: Pieter Jan VAN DER ZAAG, WAALRE (NL); Roland Cornelis Martinus VULDERS, EINDHOVEN (NL); Marie PODENPHANT JENSEN, Allerød (DK)

(21) Appl. No.: 16/468,232

(22) PCT Filed: Dec. 13, 2017
(86) PCT No.: PCT/EP2017/082623

§ 371 Date: Jun. 10, 2019

(30) Foreign Application Priority Data
Dec. 13, 2016 (EP) 16203714.7

(51) Int. Cl. B01L 3/00

(52) U.S. Cl. CPC B01L 3/502776; B01L 3/502761; B01L 2200/0668; B01L 2400/086; B01L 2300/0867; B01L 2400/0487; B01L 2300/0816

(57) ABSTRACT

The present invention relates to a microfluidic device suitable for accommodating, isolating, treating and/or processing cells. The device comprises an inlet chamber in fluid communication with at least one feeding channel being arranged in an essentially horizontal direction. The inlet chamber is suitable for receiving a volume of a liquid sample comprising at least one cell, and has an opening at its upward facing end which has a circular, ellipsoidal or polygonal cross-section. Further, the microfluidic device has a chute structure which defines a flow path for guiding the cells from the inlet chamber into the at least one feeding channel.

### CROSS-REFERENCE TO RELATED APPLICATIONS

The present document claims the benefit of and the priority to an application for a “Microfluidic device for accommodating, isolating, treating and/or processing cells having an inlet chamber with a chute structure” filed with the European Patent Office, and there duly assigned serial number EP 16 203 714. The content of said application is incorporated herein by reference for all purposes in its entirety including all figures, and claims—as well as including an incorporation of any element or part of the description, claims or drawings not contained herein and referred to in Rule 20.5(a) of the PCT, pursuant to Rule 4.18 of the PCT.

### FIELD OF THE INVENTION

The invention relates to microfluidic devices for accommodating and/or processing cells.

### BACKGROUND OF THE INVENTION

The following discussion of the background of the disclosure is merely provided to aid the reader in understanding the invention and is not admitted to describe or constitute prior art to the present invention.

Development of nucleic acid (NA) sequencing technology has undergone rapid development to the level that sequencing is being applied in diagnostics for cancer treatment. Thus far most attemps have focused on using mutations in the DNA to determine which type of treatment/drug a cancer patient has to undergo/use. Indeed some cases exist in which there is a clear link between mutations in the DNA of cancerous tissue and the drug treatment to be used, e.g. HER2-neu gen leading to the overexpression of the HER2 receptor which stimulates uncontrolled cell division. In that case, Herceptin offers generally a good treatment dealing with the overexpression Her2 receptor. Generally, however, finding direct links between DNA mutation and the cancer type and which drugs to provide is difficult as the DNA of tumor cell contains many mutations and it is difficult to assess which are the driver mutation and which are passerby mutation.

Recently, Wim Verhaegh and Anja van de Stolpe [1,2] and colleagues have shown that a more productive way of assessing tumors by nucleic sequencing and to assess what therapy to apply is to:
1. First assess which of the ten or so developmental pathways is active through expression analysis or RNA sequencing and once this has been established,
2. Secondly establish through DNA analysis where in the development pathway the disruption occurs, so that the right (targeted) drug can be selected.

A further key clinical development is the importance of Circulating Tumor Cells (CTCs). For patients with metastatic cancer this would be the only way to analyze the tumor, as it not possible to biopsy all the metastases; either because the metastases are at difficult to reach places or because there are too many of them. From circulating tumor cells in the blood one then would need to do the complete analysis e.g. do the complete pathway analysis including a RNA and subsequent DNA analysis (see above)

However, this approach requires that single cells are being analyzed as discussed, as usually CTCs have a background of white blood cell making it impossible to quantify the expression level, as the amount of CTCs in the sample is unknown. Obtaining the information from single cells solves this problem.

Experiments to isolate both the DNA and RNA of a single cell have been done with a microfluidic device as shown in FIG. 2. Said device is disclsoed in international patent application PCT/EP2016/077621 and van Strijp et al. [3], the contents of which are incorporated by reference herein. Van Strijp et al. has been published after the priority date of the present document.

Although this microfluidic device works well to isolate and amplify both the DNA and RNA from single cells, the capture efficiency of the overall cartridge might be insufficient for some specific applications. On average, 7 cells out of 7000 applied to the inoput chamber are actually captured. This 1:1000 ratio may be insufficient to work with specific samples, in which, per given volume, only a few cells are found. A 7.5 ml blood sample of a patient, for example, typically comprises less than 100 CTCs. In samples of such type, the capture ratio needs to be higher to enable a meaningful analysis.

There is hence a need for microfluidic devices suitable for accommodating, isolating, treating and/or processing cells, in particular single cells within the microfluidic device, which provide a better capture ratio, i.e., a better ratio between the number of cells delivered to the inlet chamber and the number of cells which are actually fed into the system.

### SUMMARY OF THE INVENTION

According to a first aspect, the present invention provides a microfluidic device suitable for accommodating, isolating, treating and/or processing cells, the device comprising an inlet chamber in fluid communication with at least one feeding channel, and further a chute structure which defines a flow path for guiding the cells from the inlet chamber into the at least one feeding channel.

According to a second aspect, the present invention provides a method for manufacturing a microfluidic device according to the first aspect.

According to a further aspect, the present invention provides the use of such microfluidic device for accommodating, isolating, treating and/or processing of cells.

The microfluidic device according to the first aspect is suitable for accommodating, isolating, treating and/or processing of cells, and comprises an inlet chamber in fluid communication with at least one feeding channel. The feeding channel is arranged in an essentially horizontal direction. The inlet chamber is suitable for receiving a volume of a liquid sample comprising at least one cell, and has an opening at its upward facing end which has a circular, ellipsoidal or polygonal cross-section. The inlet chamber is designed to receive the liquid sample via this opening. The opening is an opening to the ambience. Further, the microfluidic device includes a chute structure which defines a flow path for guiding the cells from the inlet chamber into the at least one feeding channel.

In some embodiments the inlet chamber of the microfluidic device is connected to a feeding channel. In some embodiments the inlet chamber of the microfluidic device is connected to a feeding channel in such a way that passage of cells is allowed to the feeding channel. In some embodiments the inlet chamber of the microfluidic device is connected to a feeding channel in such a way that passage of cells is allowed from the opening of the inlet chamber to the feeding channel.

In some embodiments the microfluidic device includes a filter. In some embodiments the microfluidic device includes a membrane. In some embodiments the microfluidic device does not include a filter. In some embodiments the microfluidic device does not include a membrane.

The microfluidic device further contains a chute structure which defines a flow path for guiding the cells from the inlet chamber into the at least one feeding channel. The chute structure may be positioned within the microfluidic device or be provided as a geometric design of an element of the microfluidic device. The chute structure may for example be a geometric element arranged within the inlet chamber. In such an embodiment the geometric element defining the chute structure may have a sloped surface, the lower side of which is arranged at the inlet of a feeding channel. The chute structure may also be arranged in the transition section between the inlet chamber and at least one feeding channel. In such an embodiment the chute structure may be defined by a gradual or stepwise tapering of the cross section of the feeding channel.

As used herein, the term “chute structure” refers to a structure that has an inclined plane or a staircase shaped layout, which defines a direction along which cells can pass. The movement of the calls is driven by directional liquid flow and/or gravity forces.

The chute structure allows a better transfer of cells into the feeding channel, hence improving the yield of cells that enter the latter and can then be fed to the device for subsequent accommodation, isolation, treatment and/or processing. The chute structure avoids sedimentation of the cells in the inlet chamber, which would otherwise keep them from being efficiently fed into the system. It is hence important to understand that this system provides a better capture ratio, i.e., a better ratio between the number of cells delivered to the inlet chamber and the number of cells which are actually fed into the system.

Hence, the system provides advantages in accommodating, isolating, treating and/or processing cells, not only in order to enable the processing and/or sequencing of nuclear and/or extranuclear constituents of a single cell, but also for other purposes which require the isolation, treatment and/or processing of cells, in particular single cells. Such other purposes encompass cell sorting , like FACS, flow cytometric single cell analysis, and the like.

In some embodiments the chute structure is arranged in the inlet chamber and comprises a sloped surface the lower side of which is arranged at the inlet of at least one feeding channel.

In some embodiments the sloped surface has a convex curvature suitable for focusing and/or directing the flow path towards the inlet of the at least one feeding channel.

In some embodiments the chute structure is arranged in the transition section between the inlet chamber and at least one feeding channel, and comprises a gradual or stepwise tapering of the feeding channel's cross section.

In some embodiments the chute structure further comprises a gradual or stepwise slope in the feeding channel's lower surface.

In some embodiments the horizontal feeding channel has a circular, ellipsoidal or polygonal cross section. The horizontal feeding channel may for instance have a rectangular or square cross section.

In some embodiments, in the transition section, the horizontal feeding channel has an initial height of between ≥50 μm and ≤200 μm, which height gradually or stepwise tapers to between ≥8 μm and ≤50 μm.

In some embodiments, at least stretches of the inlet chamber and/or the feeding channel comprise an anti-adhesive coating surface. Such coating or surface can, for example, comprise a lotus effect surface or coating, a coating comprising a poloxamer, also known as e.g. Pluronic® (e.g., Poloxamer 188, also known as Pluronic®F-68, or Poloxamer 407, also known as Pluronic® F-127), Polytetrafluorethylene, or a Ultra-Low Attachment surface as provided, e.g. by Corning. This feature reduces cell adhesion to the surface of the inlet chamber and/or the feeding channel, which would otherwise keep the cells from being efficiently fed into the system.

In some embodiments, the diameter of the inlet chamber is between ≤4 mm, preferably ≤3 mm, more preferably ≤2 mm and most preferably ≤1 mm. This feature increases the speed of the lateral flow and hence reduces cell adhesion to the surface of the inlet chamber and/or the feeding channel, as well as cell sedimentation. Both phenomena would otherwise keep the cells from being efficiently fed into the system. It is to be understood that the diamater of the inlet chamber should not fall below a critical mimimum diameter which is ≥100 μm. This embodiment contributes to increase the flow of cells into the at least one feeding channel.

In some embodiments the microfluidic device further comprises
at least one inlet structure and/or channel for accommodating and/or directing a buffer liquid
at least one trapping structure for capturing a single cell,
at least one outlet channel in fluid connection with the at least one trapping structure, and/or
at least one valve for directing the flow of liquid within the microfluidic structure.
   Further details of such microfluidic device and its uses are discussed elsewhere herein.

The term “cell” as used herein refers to living cells, preferably to eukaryotic cells, more preferably to mammalian cells, and most preferably to human cells.

The feeding channel comprises at least a first end. The feeding channel's first end is an open end and represents an inlet for providing cells to be captured to the microfluidic structure of the microfluidic device.

In one embodiment, the inlet chamber comprises a fitting for attaching a reservoir—such as a bag or syringe—containing cells to be accommodated, isolated, treated and/or processed. In antother and/or alternative embodiment, the fitting is a female Luer-Lok fitting.

The feeding channel comprises preferably a second end. Said second end can be an open end. Said second end of the feeding channel preferably acts as an outlet. In an embodiment of the feeding channel, the second end of the feeding channel is in fluid communication with a waste reservoir. Said waste reservoir is configured for receiving liquid that is flowing through the feeding channel as well as cells that are not captured by the trapping structure.

In an additional and/or alternative embodiment, the feeding channel has an inner width of at least about 20 μm, preferably of at least about 30 μm, more preferably of at least about 35 μm, and most preferably of about 40 μm. The feeding channel has an inner width of less than about 100 μm, preferably of less than about 60 μm, more preferably of less than about 50 μm. The inner width of the feeding channel is ideally between about 35 μm and about 45 μm.

In an additional and/or alternative embodiment, the feeding channel has a height of 50 μm, preferably a height in the range of about 8 μm to about 20 μm, more preferably in the range of about about 10 μm to about 15 μm, most preferably of about 10 μm.

The microfluidic structure may further comprise a trapping structure for capturing a cell migrating through the feeding channel. The trapping structure is configured as a bulge of the feeding channel, said bulge extending orthogonally from one side of the flow path within the feeding channel. The axis of the trapping structure extends essentially perpendicular from the longitudinal axis of the feeding channel in the section of the feeding channel where the trapping structure bulges is located. Thus, the trapping structure for capturing a single cell is not positioned within the flow path of the feeding channel.

In additional and/or alternative embodiments, the trapping structure has a rectangular, square, round or oval cross scetion. In an additional and/or alternative embodiment, the trapping structure is a conical or funnel-shaped bulge of the feeding channel's lumen. In another embodiment, the trapping structure is wedge-shaped.

The trapping structure comprises an open 1^{st} end and an open 2^{nd} end. The open 1s^{t} end is in fluid communication with the lumen of the feeding channel, whereas the open 2^{nd} end is in fluid communication with an output channel. In an additional and/or alternative embodiment, the open 1^{st} end and the open 2^{nd} end of the trapping structure are arranged at opposite ends of the trapping structure. The diameter of the open 1^{st} end is larger than the diameter of the aperture of the 2^{nd} end. In an additional and/or alternative embodiment, the open 1^{st} end of the trapping structure has a cross-sectional diameter of about two times of the size of the cell to be captured. In an additional and/or alternative embodiment, the open 1^{st} end of the trapping structure has a cross-sectional diameter of about 20 μm, preferably of about 15 μm such that typically only a single cell is captured in an individaul trapping structure of the trapping device. A wedge-shaped trapping structure may posses a trapping structure comprising an open 1^{st} end having a width of about 20 μm or about 15 μm and a hight of about 10 μm.

The diameter of the aperture of the 2″ end is preferably about 4 μm. The width and hight of the aperture of the second end of a wedge-shaped trapping structure is preferably 4 μm by 10 μm.

The trapping structure is in fluid communication with an output channel. The output channel comprises a first end and a second end. The output channel's first end in an open end having an aperture. Said aperture is in fluid connection with the aperture of the trapping structure's second open end. Said fluid connection provides a narrow section, the inner diameter or width of which being such that a cell captured in the trapping device can not pass through said fluid connection at operable pressure/flow rates. More specifically, the dimension of the inner diameter or width of the fluid connection is such that the nucleus of a captured cell cannot pass through at operable pressure/flow rates too. Preferably, the narrow section/fluid connection has an inner diameter or width in the range of about 1 μm to about 4 μm.

The optional second end of the output channel is an open end. In a preferred embodiment, said second end of the output channel fluidly connectable with at least one auxiliary chamber. Preferably, said at least one auxiliary chamber is a reaction chamber for analyzing and/or amplifying constituents obtained from the cell caught in the trap.

In some embodiments, the output channel has an inner diameter in the range of between about 25 μm and about 35 μm. A preferred embodiment of an output channel has a width of between about 25 μm and about 35 μm, and a hight of about 10 μm.

In some embodiments, the output channel is branched. That it, the output channel comprises two or more second ends. Hence, the output channel of this embodiment comprises two or more legs. Preferably, each leg provides a flow path to a separate auxiliary chamber.

In some embodiments, the two or more legs of the output channel are provided with one or more valves. Said valves allow to determine which flow path is used at any time, and permits changing the flow path through the output channel along one or another leg of the output channel. This embodiment is advantageous for directing constituents obtained from the cell to separate/differnt auxiliary chambers for separate further processing and/or analysis. For example, the auxiliary chambers may be configured for performing nucleic acid amplification reactions such as polymerase chain reactions.

The microfluidic structure optionally comprises at least one buffer channel for supplying one or more buffers to the feeding channel. In a preferred embodiment, the microfluidic structure comprises two buffer channels. The at least one buffer channel is configured for guiding the cells flowing in the feeding channel towards the side of the feeding channel where the trapping structure is located and/or for supplying a lysis buffer to the captured cell.

Said at least one buffer channel has a 1^{st} end and a 2^{nd} end. The 1^{st} end of the at least one buffer channel is an open end. In an embodiment, the 1^{st} end of the at least one buffer channel is in fluid communication with a buffer reservoir for supplying buffer to the buffer channel within the microfluidic structure. In an additional and/or alternative embodiment, the 1^{st} end of the at least one buffer channel comprises a fitting for attaching a reservoir such as, for example, a bag or. In an embodiment, the fitting is a Luer-Lok fitting, preferably a female Luer-Lok fitting.

In embodiments of the microfluidic structure having two or more buffer channels, it is preferred that each of the two or more buffer channels is in fluid communication with a separate buffer reservoir.

The second end of the at least one buffer channel is an open end. Said open end is an aperture that is in fluid communication with the feeding channel. Said aperture is an outlet for providing the buffer flowing within the buffer channel to the feeding channel. The outlet of the at least one buffer channel is positioned at the opposite side of the at least one trapping structure with respect to the feeding channel's cross section. The outlet of the at least one buffer channel is not positioned directly opposite the trapping structue, but at a distance before the trapping structure, with respect to the direction of flow through the feeding channel.

In an additional and/or alternative embodiment, the at least one buffer channel is fluidly connected to the feeding channel in a tilted orientation such that the flow path within the at least one buffer channel converges with the flow path of the feeding channel in a sharp angel, i.e. in an angle of smaller than 90°. The angle between the feeding channel and the at least one buffer channel is in the range of about 30° to about 70°, preferably in the range of about 40° to about 60°, and most preferably in the range of about 45° to about 55°. In an additional and/or alternative embodiment, the angle is about 50°. The tilting of the at least one buffer chamber is advantageous in that the flow of buffer from the at least one buffer chamber drive migration of the cells along the feeding channel from the cell inlet towards the waste outlet. In addition, the flow of buffer from the at least one buffer channel forces the cell migrating along the feeding channel towards the side of the feeding channel bearing the trapping structure by. This configuration increases the efficacy of capturing a cell flowing through the feeding channel by the trapping structure.

In an additional and/or alternative embodiment, the microfluidic structure comprises one or more valves for opening and/or closing specific flow paths in the microfluidic structure, and for directing the flow of liquid through the channels of the microfluidic structure and microfluidic device. For example, the cell inlet and/or the waste outlet of the feeding channel may be provided with a valve, the buffer inlet and/or the outlet of each buffer channel may be provided with a valve, and/or the inlet and/or outlet of the output channel may be provided with a valve.

In an additional and/or alternative embodiment, the microfluidic device comprises at least one auxiliary chamber for further processing nuclear and/or extranuclear constituents of a single cell. The term “processing” in this regard comprises reaction for analyzing, detecting, characterizing, amplifying and/or sequencing a constituent of a cell. The at least one auxiliary chamber may be integral part of the microfluidic structure such that the at least one auxiliary chamer is in fluid connection with the output channel. In an alternative embodiment, the at least one auxiliary chamber is connectable to the output channel for establishing a fluid connection for transferring the cell's constituents into the auxiliary chamber. The latter embodiment has the advantage that different auxiliary chambers can be connected to the output channel for differently procesing nuclear and extra-nuclear constituents of the cell.

A microfluidic device comprising a microfluidic structure according to the invention is advantageous in that the cells to be captures can be captured while in a fluid (such as a FACS flow or PBS (=phosphate buffered saline) buffer) maintaining integrity of the cell, and that the cell can subsequently be lysed directly in the trapping structure by supplying a lysis buffer such that any of the cell's constituents can be released dirctly into the output channel which may contain a liquid suitable for further processing the constituents for detection and/or analysis. It has surprisingly been found that additional changes of fluids and washing steps, which are typically used when cells are lysed, are not necessary. The amount of lysis buffer transferred into the output channel is neglectable with respect to its effect on inhibiting subsequent reactions for determining and/or analyzing a cell's constituent. For example, a typical lysis buffer for isolating DNA contains salts and a surfactant which are known to inhibit amplification of DNA fragments by polymerase chain reaction.

Without wishing to be bound, it is believed that the advantage of the microfluidic structure is based on the configuration wherein the main flow direction in the feeding channel is orthogonal to the fluidic direction in the trapping structure towards the outlet and the ratio between the cross-sectional area of the feeding channel and the cross-sectional area of the outlet aperture of the trapping structure/narrow section. It is believed that these features contribute to the fact that only a minute, neglectable amount of lysis buffer accesses the output channel upon lysis of a cell captured in the trapping structure. For example, the volume of a trapping structure measuring ½×15 μm×15 μm×10 μm is equivalent to about 1.1 pl. Thus, if the entire content of such a trap enters the output channel bearing a volume of about 10 μl of prefilled fluid, the amount of lysis buffer summs up to only 1:10⁷. This minor amount of lysis buffer in the buffer within the output channel does not affect subsequent analysis and/or amplification of specific cell constituents. Even if a lysis buffer containing guanidinium (CH₅N₃) salts is used, the residual amount thereof does not affect subsequent nucleic acid amplification, even if the amplification reaction is performed in said 10 μl volume.

Guanidinium salts can be used in the rapid purification of nucleic acids directly from serum or urine. However, a silica membrane or silica coated beads have to be used to collect/bind the nucleic acids to those beads/membranes, before washing away the guanidinium salts by isolating the beads or washing the membrames. In using the microfluidic device described herein, neither a silica membrane nor silica coated beads are required, not even an extra step for washing away the guanidinium salt when the cell's constituent to be isolated is a nucleic acid.

In an additional and or alternative embodiment, the microfluidic structure is configured such that the ratio of the volume of the trapping structure to the volume of the output channel is at least about 1:10³, at least about 1:10⁴, at least about 1:10⁵, at least about 1:10⁶ or even at least 1:10⁷.

In additional and/or alternative embodiments, the microfluidic device comprises one or more of said microfluidic structures. In additional and/or alternative embodiments, the microfluidic device comprises additional microfluidic structures such as, for example, microfluidic structures for pinched flow fractionation of cells, or for performing analyzing and/or amplifying reactions using the constituents obtaind from captured cells.

The microfluidic device enables differential analysis of the different nucleic acid species of a single cell.

According to a second aspect of the invention, a method of manufacturing a microfluidic device as defined above is disclosed, wherein the microfluidic structure is produced by injection molding of a polymer, and subsequently sealing the channels by bonding a polymer film to the molded structure. Alternatively, the microfluidic structure is produced by depositing various layers of injection molded polymer. Preferably, such polymer is selected from the thermoplastics group consisting of, but not limited to, acrylics, nylons, polycarbonate, polyether imide, polyoxmethylene, polypropylene, polystyrene and polyvinylchloride. Additionaly optical grade plastics could be used, suitable plastic materials include cyclo olefin polymer (COP), polycarbonate (PC), polystyrene (PS), polymethylmethacrylate (PMMA), and styrene-butadiene copolymers (SBC).

Said sealing of the film can be accomplsihed for example by means of UV-assisted thermal bonding of the polymer film to the injection molded structure bearing the microfluidic channels. Both manufacturing methods permit generating channels having a predefiend width and typically the same hight. This method of manufacturing microfluidic structures as such in known in the technical field of microfluidic devices.

According to a further aspect, the present invention provides the use of such microfluidic device for accommodating, isolating, treating and/or processing of cells. Such use may encompass, e.g., differentially extracting nucelar and extra-nuclear constituents of a single cell. The use comprises capturing a single cell in the at least one trapping structure of the microfluidic structure, lysing the cell while maintaining integrity of the cell's nucleus, and subsequently lying the cell's nucleus such that extra-nuclear and the nuclear constituents of the cell are released successively to be processed separately from each other. In an additional embodiment, the use of the microfluidic structure according to the first aspect comprises subsequent analyzing/characterizing at least one of the nuclear and/or extra-nuclear constituents of the cell.

In an additional and/or alternative embodiment, the nuclear constituents of the cell and/or the extra-nuclear constituents of the cell are nucleic acid molecules. The nuclear nucleic acid is preferably the cell's DNA. The extra-nuclear nucleic acid is preferably the cell's mRNA.

In using the the microfluidic device for differentially extracting nuclear and extra-nuclear constituents of a single cell the method described herein after can be employed.

For delivering at least one cell to the feeding channel via the chute structure, one or more cells are present in a liquid sample which maintains integrity and viability of the cells. Said fluid is an isotonic fluid, for example a FACS-flow-buffer or PBS. Said fluid containg the at least one cell is delivered to the inlet chamber, which is in fluid connection with at least one feeding channel, such that the liquid enters the feeding channel at its cell inlet. The chute structure ensures that a high share of cells is actually delivered to the feeding channel.

Optionally a force may be exerted for securing that the fluid is flowing through the feeding channel at a desired flow rate. Preferably, the flow rate of the fluid is in the range of between 2.9 μL/h to about 5.7 μL/h. This may—depending on the dimensions of the channels - correspond to a pressure in the range between about 2 mbar to about 10 mbar, preferably from about 3 mbar to about 5 mbar.

A cell being present in said fluid enters the feeding channel at its first end and migrates along the feeding channel due to the flow of fluid until the cell passes the trapping structure. The cell enters the trapping structure due to the microfluidic dynamics within the microfluidic struture, and is captured in the trapping structure. The cell being captured in the trapping structure clogs the aperture at the trapping structure's 2^{nd} end.

In some embodiments, additional fluid maintaining integrity and viability of the cell is supplied to the feeding channel from at least one separate buffer reservoir via the buffer channel or via at least one of the buffer channels. The converging flows of fluids in the feeding channel drives migration of the cells along the flow path of the feeding channel, and towards the side of the feeding channel opposite to the outlet of the buffer channel supplying the buffer or medium. A single cell is then captured in the at least one trapping structure present along the subsequent flow path within the feeding channel when the cell passes the position of one of the trapping structures. As long as a cell is captured in a trapping structure no further cell can be trapped in the same trapping structure.

The use and/or method further comprises lysing the cell being captured in the trapping structure. The cell is lysed such that the integrity of the cell's nucleus is not affected. For lysing the cell, a first lysis buffer is supplied to the feeding channel and to the captured cell after cells which are not captured in a trapping structure of the microfluidic device are removed from the feeding channel. Supplying the first lysis buffer to the feeding channel may be performed using the cell inlet of the feeding channel. In an additional and/or alternative embodiment, the first lysis buffer is supplied to the feeding channel and to the captured cell via the buffer channel or via at least one of the buffer channels. Hence, the same buffer channel supplying the fluid maintaining integrity and viability of the cell or another buffer channel may be used for supplying the first lysis buffer to the feeding channel/trapping structure/captured cell. Supplying the first lysis buffer via at least one of the buffer channels is advantaeous in that once a cell, or a number of cells being captured when mutiple trapping structures are present along the feeding channel, the process of lysing the cells can immediately be started.

In an additional embodiment, the first lysis buffer consists of 0.5× TBE containing 0.5% (v/v) polyoxyethylene octyl phenyl ether, also known as Triton X-100. Thus, this first lysis buffer consists of an aqueous solution containing 44.5 mM Tris-Borate, 1 mM EDTA and 0.5% (v/v) Triton X-100. The first lysis buffer does not affect integrity of the cell's nucleus, but leaves it intact. This first lysis buffer is particularly suitable for analysing the cell's transcrptome by subsequent reverse transcription and PCR amplification of mRNA molecules of the cell.

The extra-nuclear constituents of the captured cell are then release from the trapping structure into the narrow section of the output channel connecting the outlet at the 2^{nd} end of the trapping structure with the inlet of the output channel, wherein no or only a neglectable minute amount of the first lysis buffer enters said narrow section.

In an alternative and/or additional embodiment, the output channel contains a buffer or fluid suitable for performing the desired reaction(s) for analysing and/or characterizing a extracellular constituent of the cell. Hence, the captured cell is lysed and its constituents are release and transferred to the output channel containing a buffer or fluid, e.g. FACS-flow, PBS or a PCR buffer, that does not hamper subsequent detection and/or more specific molecule(s) of the cell, such as a specific protein, a nucleic acid sequence and/or a metabolite.

In a further step, the cell's extra-nuclear constituents are transferred from the narrow section to the output channel and are transferred from the output channel to an auxiliary chamber for further processing, i.e. for detection and/or analysis.

Upon lysing the cell with said first lysis buffer, integrity of the cell's nucleus is not affected. Due to the dimensions of the trapping structures outlet and the narrow section, the intact nucleus can not pass through the outlet at the trapping structure's 2^{nd} end and the narrow secction into the output channel, but is captured in the trapping structure.

In a further step, the nucleus of the cell is lysed. The nucleus is lysed in that a second lysis buffer, the composition of which is different from the composition of the first lysis buffer, is supplied to the feeding channel and to the nucleus being captured in the trapping structure. Supplying the second lysis buffer to the feeding channel may be performed using the cell inlet of the feeding channel. In an additional and/or alternative embodiment, the second lysis buffer is supplied to the feeding channel and to the captured nucleus via the buffer channel or via at least one of the buffer channels. Hence, the same buffer channel supplying the first lysis buffer and/or another buffer channel may be used for supplying the second lysis buffer to the feeding channel/trapping structure/captured cell. Supplying the second lysis buffer via another buffer channel that the first lysis buffer is particularly advantageous in that, the process of lysing the nucleus can immediately be started.

In an additional embodiment, the second lysis buffer consists of 0.5× TBE containing 0.5% (v/v) Triton X-100 supplemented with protease K, preferably with a 1:70 dilution of a protease K. Thus, this second lysis buffer consists of an aqueous solution containing 44.5 mM Tris-Borate, 1 mM EDTA, 0.5% (v/v) Triton X-100 and protease K.

The nuclear constituents of the cell are then release from the trapping structure into the narrow section of the output channel connecting the outlet at the 2^{nd} end of the trapping structure with the inlet of the output channel, wherein no or only a neglectable minute amount of the second lysis buffer enters said narrow section.

In an alternative and/or additional embodiment, the output channel contains a buffer or fluid suitable for performing the desired reaction(s) for analysing and/or characterizing a extracellular constituent of the cell. Hence, the nucleus is lysed and its constituents are release and transferred to the output channel containing a buffer or fluid, e.g. FACS-flow, PBS or a PCR buffer, that does not hamper subsequent detection and/or more specific molecule(s) of the cell, such as a specific protein, a nucleic acid sequence and/or a metabolite.

In a further step, the cell's nuclear constituents are transferred from the narrow section to the output channel and are transferred from the output channel to an auxiliary chamber for further processing, i.e. for detection and/or analysis. Preferably, the auxiliary chamber is onother, optionally different, auxiliary chamber than the auxiliary chamber the extra-nuclear constituents were transferred to.

In additional embodiment, the method further comprises:
amplification of at least one nucleic acid sequence of the cell's nuclear constituents; and
amplification of at least one nucleic acid sequence of the cell's extra-nuclear constituents.

In an additional embodiment, the method further comprises analyzing the nucleotide sequence of the amplification product of the at least one nucleic acid sequence of the cell's nuclear constituents.

The method does not require separate washing steps after the cell and/or the nucleus have been lysed for removing residual lysis buffer containing compound affecting or even impairing a subsequent analysis of constituents. This reduces time and chemicals required for analyzing cells, and thus costs.

### BRIEF DESCRIPTION OF THE DRAWINGS

These and other aspects of the invention will be apparent from and elucidated with reference to the embodiments described hereinafter. Such embodiment does not necessarily represent the full scope of the invention, however, and reference is made therefore to the claims and herein for interpreting the scope of the invention.

In the drawings:

FIG. 1 shows a schematic illustration of an embodiment of a microfluidic structure in accordance with the invention.

FIG. 2 shows the layout of a microfluidic device suitable for accommodating, isolating, treating and/or processing cells, with an inlet structure indicated by an arrow.

FIG. 3 shows a perspective view of an inlet chamber with a chute structure according to the invention.

FIG. 4 shows a cross section of a transition section between an inlet chamber and a feeding channel, with another chute structure according to the invention.

### DETAILED DESCRIPTION OF EMBODIMENTS

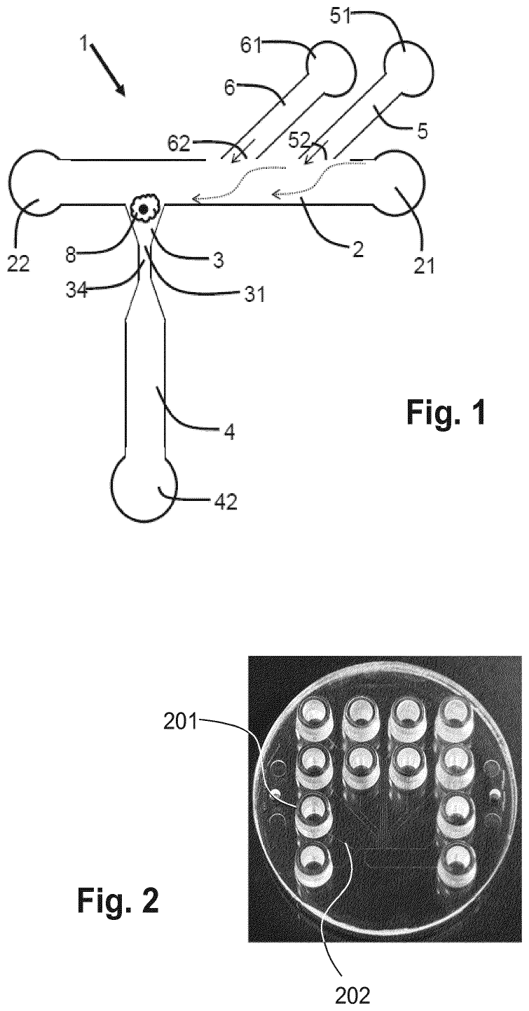

Referring to FIG. 1, a schematic illustration of an embodiment of a microfluidic structure in accordance with the invention is shown. The microfluidic structure comprises a feeding channel 2 possessing an inlet (cell inlet) 21 and a waste outlet (22). The microfluidic structure 1 comprises a trapping structure 3 in fluid communication with and orthogonally extending from the flow path of the feeding channel 2. The trapping structure 3 comprises an outlet 31 in fluid connection with an output channel 4. The fluid connection 34 between the trapping structure 3 and the output channel 4 provides a narrow section configured to prevent a cell 8 being captured in the trapping structure 3 from accessing the output channel 4. The output channel 4 possesses an outlet 42 which is or may get fluid connection with an auxiliary chamber which is configured for detecting and/or analyzing one or more cell constituents. The microfluidic structure 1 further comprises two buffer channels, a first buffer channel 5 and a second buffer channel 6. The first buffer channel 5 being in fluid communication with a first buffer reservoir 51, and the second buffer channel 6 in fluid communication with a second buffer reservoir 61. Optionally one of the first buffer reservoir 51 and the second buffer reservoir 61 contains a fluid maintaining integrity and viability of cells, whereas the other buffer reservoir contains a lysis buffer for lysing a cell captured in the trapping structure 3.

During operation, a flow of buffer or medium is provided via at least one of the buffer channels 5, 6 as indicated by the solid arrows. A cell migrating along the feeding channel 2 is forced within the feeding channel 2 towards the side opposite of the outlet 62 of the buffer channel 5 and/or 6 to be captured by the trapping structure 3 also located at the side of the feeding channel opposite to the outlets 52, 62 of the buffer channels 5, 6.

Referring to FIG. 2, a respective microfluidic device is shown. The inlet chamber 201 is in fluid communication with a feeding channel 202 arranged in an essentially horizontal direction in the microfluidic device. The inlet chamber is suitable for receiving a volume of a liquid sample comprising at least one cell.

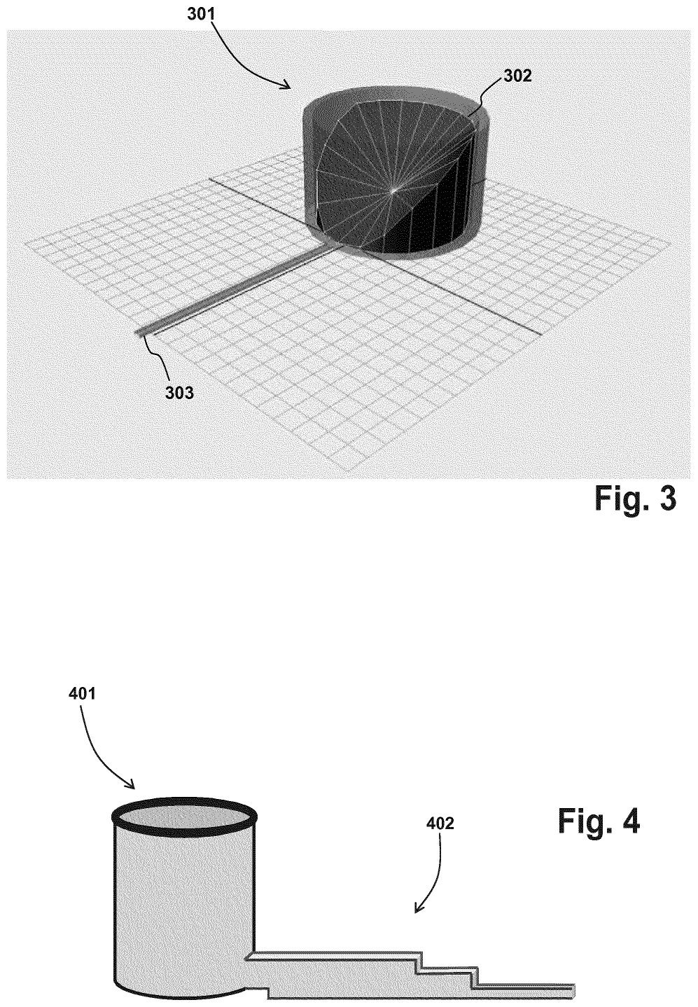

Referring to FIG. 3, an inlet chamber 301 is shown which has an opening at its upward facing end, which opening has a circular cross-section. The inlet chamber further comprises a chute structure 302 which comprises a sloped surface the lower side of which is arranged at the inlet of a feeding channel 303. The chute structure defines a flow path for guiding cells from the inlet chamber 301 into the feeding channel 303, and has a convex curvature symbolized by the radially arranged lines, which curvature is suitable for focusing and/or directing the flow path towards the inlet of the feeding channel 303.

Referring to FIG. 4, an inlet chamber 401 is shown together with a chute structure 402 which is arranged in the transition section between the inlet chamber and a feeding channel 403. The chute structure comprises a stepwise tapering of the feeding channel's cross section. In other embodiments, the tapering can be gradual instead of stepwise.

The chute structures allow a better transfer of cells into the feeding channel, hence improving the yield of cells that enter the latter and can then be fed to the device for subsequent accommodation, isolation, treatment and/or processing. The chute structures avoid sedimentation of the cells in the inlet chamber, which keeps them from being efficiently fed into the system.

REFERENCE SYMBOL LIST

| | |
|---|---|
| 1 | microfluidic structure |
| 2 | feeding channel |
| 3 | trapping structure |
| 4 | output channel |
| 5 | first buffer channel |
| 6 | second buffer channel |
| 7 | valve |
| 8 | cell |
| 10 | microfluidic structure |
| 21 | cell inlet |
| 22 | waste outlet |
| 31 | outlet |
| 33 | trapping structure |
| 34 | narrow section |
| 42 | outlet |
| 43 | leg |
| 44 | leg |
| 51 | buffer reservoir |
| 52 | outlet |
| 61 | buffer reservoir |
| 62 | Outlet |
| 431 | outlet |
| 441 | outlet |
| 201 | inlet chamber |
| 202 | feeding channel |
| 301 | inlet chamber |
| 302 | chute structure |
| 303 | feeding channel |
| 401 | inlet chamber |
| 402 | chute structure |
| 403 | feeding channel |

### REFERENCES

[1] W. Verhaegh et al., Cancer 74 (2014) 2936.

[2] W. Verhaegh and A. van de Stolpe, Oncotarget 5 (2014) 5196.

[3] D. van Strijp et al., Scientific Reports 7 (2017) 11030.

1. A microfluidic device suitable for accommodating, isolating, treating and/or processing cells, the device comprising an inlet chamber connected to a feeding channel in such a way that passage of cells is allowed from the opening of the inlet chamber to the feeding channel, the feeding channel being arranged in an essentially horizontal direction,
wherein the inlet chamber is suitable for receiving a volume of a liquid sample comprising at least one cell,
wherein the inlet chamber has an opening at its upward facing end which has a circular, ellipsoidal or polygonal cross-section,
wherein the microfluidic device further comprises a chute structure which defines a flow path for guiding the cells from the inlet chamber into the at least one feeding channel,
wherein the chute structure is
(a) a geometric element arranged within the inlet chamber and comprises a sloped surface, the lower side of which is arranged at the inlet of at least one feeding channel, or
(b) wherein the chute structure is arranged in the transition section between the inlet chamber and at least one feeding channel, and is defined by a gradual or stepwise tapering of the cross section of the feeding channel
wherein the microfluidic device further comprises at least one trapping structure for capturing a single cell,
wherein the microfluidic device further comprises at least one outlet channel in fluid connection with the at least one trapping structure, and
wherein the axis of said trapping structure extends essentially perpendicularly from the longitudinal axis of the feeding channel.

2. The microfluidic device according to claim 1, wherein the sloped surface has a convex curvature suitable for focusing and/or directing the flow path towards the inlet of the at least one feeding channel.

3. The microfluidic device according to claim 1, wherein the chute structure is arranged in the transition section between the inlet chamber and at least one feeding channel, and wherein the chute structure further comprises a gradual or stepwise slope in the feeding channel's lower surface.

4. The microfluidic device according to claim 1, wherein the horizontal feeding channel has a circular, ellipsoidal or polygonal cross section.

5. The microfluidic device according to claim 1, wherein the chute structure is arranged in the transition section between the inlet chamber and at least one feeding channel, and wherein, in the transition section, the horizontal feeding channel has an initial height of between ≥50 μm and ≤200 μm, which height gradually or stepwise tapers to between ≥8 μm and ≤50 μm.

6. The microfluidic device according to claim 5, wherein at least stretches of the inlet chamber and/or the feeding channel comprise an anti-adhesive coating.

7. The microfluidic device according to claim 6, wherein the diameter of the inlet chamber is between ≤4 mm, preferably ≤3 mm, more preferably ≤2 mm and most preferably ≤1 mm.

8. The microfluidic device according to claim 7, which device further comprises
at least one inlet structure and/or channel for accommodating and/or directing a buffer liquid
and/or
at least one valve for directing the flow of liquid within the microfluidic structure.

9. A method of manufacturing a microfluidic device as defined in claim 1, wherein the microfluidic structure is produced by
(a) injection molding of a polymer, and subsequently sealing the channels by bonding a polymer film to the molded structure, and/or
(b) depositing various layers of injection molded polymer.

10. The use of a microfluidic device according to claim 8 for accommodating, isolating, treating and/or processing of cells.
